(19) United States
(12) Patent Application Publication
(10) Pub. No.: US 2024/0331682 A1
(43) Pub. Date: Oct. 3, 2024

(54) SYSTEMS AND METHODS FOR REAL-TIME CONCERT TRANSCRIPTION AND USER-CAPTURED VIDEO TAGGING

(71) Applicant: Mixhalo Corp., San Francisco, CA (US)

(72) Inventors: Ty Daniels, Austin, TX (US); Charles E. Luckhardt, IV, San Francisco, CA (US)

(21) Appl. No.: 18/621,320

(22) Filed: Mar. 29, 2024

Related U.S. Application Data
(60) Provisional application No. 63/456,038, filed on Mar. 31, 2023.

(51) Int. Cl. G10L 15/08; G10L 15/30; G10L 25/57; G11B 27/34

(52) U.S. Cl. CPC G10L 15/08; G10L 15/30; G10L 25/57; G11B 27/34

(57) ABSTRACT

A method for generating and displaying contextual data using a mobile computing device at a live event includes receiving a data representation of a live audio signal corresponding to the live event via a wireless network. The method also includes processing the data representation of the live audio signal into a live audio stream. The method also includes generating first contextual data based on the live audio stream and a first machine learning model. The method also includes generating second contextual data based on the live audio stream and a second machine learning model. The method also includes generating for display on the mobile computing device at the live event the first contextual data and the second contextual data.

### RELATED APPLICATION(S)

This application claims priority to U.S. Provisional Patent Application No. 63/456,038, filed on Mar. 31, 2023, the entire disclosure of which is incorporated herein by reference.

### FIELD OF THE INVENTION

This invention relates generally to the field of integration of real-time live event audio with user-captured video. More specifically, the invention relates to systems and methods for real-time transcription and tagging of live event user-captured video.

### BACKGROUND

Users attending live events often capture audio and video using their mobile computing devices with the intention of sharing their experiences on social media. For example, concertgoers often record and share segments of their experience with their social network. However, these user-captured videos are often devoid of context. For example, the location of the concert or event, the name of the artist or song currently being played, and the particular instrument being heard may provide useful contextual information that would complement a user-captured video. Users at the live event may also benefit from access to this contextual information in real-time. Therefore, there is a need for systems and methods that analyze live event audio to generate tags of contextual information in real-time.

### SUMMARY

The present invention includes systems and methods for generating and displaying contextual data using a mobile computing device at a live event and tagging the contextual data in a user-captured video. For example, the present invention includes methods and mechanisms for receiving a data representation of a live audio signal corresponding to the live event and process the data representation of the live audio signal into a live audio stream. The present invention also includes methods and mechanisms for generating contextual data based on the live audio stream and at least one machine learning model. The present invention also includes methods and mechanisms for generating for display on the mobile computing device the generated contextual data. The present invention also includes methods and mechanisms for initiating a video capture corresponding to the live event and producing a shareable video corresponding to the live event based on the captured video, the live audio stream, and the contextual data.

In one aspect, the invention includes a computerized method for generating and displaying contextual data using a mobile computing device at a live event. The computerized method includes receiving a data representation of a live audio signal corresponding to the live event via a wireless network. The computerized method also includes processing the data representation of the live audio signal into a live audio stream. The computerized method also includes generating first contextual data based on the live audio stream and a first machine learning model. The computerized method also includes generating second contextual data based on the live audio stream and a second machine learning model. The computerized method also includes generating for display on the mobile computing device at the live event the first contextual data and the second contextual data.

In some embodiments, the mobile computing device is configured to receive the data representation of the live audio signal corresponding to the live event from an audio server computing device via the wireless network.

In some embodiments, the first contextual data corresponds to sound data and the second contextual data corresponds to speech data. For example, in some embodiments, the first machine learning model includes a Signal-to-Noise Ratio (SNR) machine learning model. In some embodiments, the second machine learning model includes an Automatic Speech Recognition (ASR) machine learning model.

In another aspect, the invention includes a system for generating and displaying contextual data using a mobile computing device at a live event. The system includes a mobile computing device communicatively coupled to an audio server computing device over a network. The mobile computing device is configured to receive a data representation of a live audio signal corresponding to a live event via the wireless network. The mobile computing device is also configured to process the data representation of the live audio signal into a live audio stream. The mobile computing device is also configured to generate first contextual data based on the live audio stream and a first machine learning model. The mobile computing device is also configured to generate second contextual data based on the live audio stream and a second machine learning model. The mobile computing device is also configured to generate for display on the mobile computing device at the live event the first contextual data and the second contextual data.

In some embodiments, the mobile computing device is configured to receive the data representation of the live audio signal corresponding to the live event from the audio server computing device via the wireless network.

In some embodiments, the first contextual data corresponds to sound data and the second contextual data corresponds to speech data. For example, in some embodiments, the first machine learning model includes a Signal-to-Noise Ratio (SNR) machine learning model. In some embodiments, the second machine learning model includes an Automatic Speech Recognition (ASR) machine learning model.

In another aspect, the invention includes a computerized method for generating and tagging contextual data in a user-captured video using a mobile computing device. The computerized method includes receiving a data representation of a live audio signal corresponding to a live event via a wireless network. The computerized method also includes processing the data representation of the live audio signal into a live audio stream. The computerized method also includes generating first contextual data based on the live audio stream and a first machine learning model. The computerized method also includes generating second contextual data based on the live audio stream and a second machine learning model. The computerized method also includes initiating a video capture corresponding to the live event. The computerized method also includes producing a shareable video corresponding to the live event based on the captured video, the live audio stream, the first contextual data, and the second contextual data.

In some embodiments, the mobile computing device is configured to receive the data representation of the live audio signal corresponding to the live event from an audio server computing device via the wireless network.

In some embodiments, the first contextual data corresponds to sound data and the second contextual data corresponds to speech data. For example, in some embodiments, the first machine learning model includes a Signal-to-Noise Ratio (SNR) machine learning model. In some embodiments, the second machine learning model includes an Automatic Speech Recognition (ASR) machine learning model.

In another aspect, the invention includes a system for generating and tagging contextual data in a user-captured video using a mobile computing device. The system includes a mobile computing device communicatively coupled to an audio server computing device over a network. The mobile computing device is configured to receive a data representation of a live audio signal corresponding to a live event via the wireless network. The mobile computing device is also configured to process the data representation of the live audio signal into a live audio stream. The mobile computing device is also configured to generate first contextual data based on the live audio stream and a first machine learning model. The mobile computing device is also configured to generate second contextual data based on the live audio stream and a second machine learning model. The mobile computing device is also configured to initiate a video capture corresponding to the live event. The mobile computing device is also configured to produce a shareable video corresponding to the live event based on the captured video, the live audio stream, the first contextual data, and the second contextual data.

In some embodiments, the mobile computing device is configured to receive the data representation of the live audio signal corresponding to the live event from the audio server computing device via the wireless network.

In some embodiments, the first contextual data corresponds to sound data and the second contextual data corresponds to speech data. For example, in some embodiments, the first machine learning model includes a Signal-to-Noise Ratio (SNR) machine learning model. In some embodiments, the second machine learning model includes an Automatic Speech Recognition (ASR) machine learning model.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for wireless capture of real-time audio and video at a live event using a mobile computing device, according to an illustrative embodiment of the invention.

FIG. 2 is a schematic diagram of a system architecture for real-time analyzing of live event audio and tagging of user-captured video using a mobile computing device, according to an illustrative embodiment of the invention.

FIG. 3 is a schematic flow diagram of a process for generating and displaying contextual data at a live event using the system architecture of FIG. 2, according to an illustrative embodiment of the invention.

FIG. 4 is a schematic flow diagram of a process for generating and tagging contextual data in a user-captured video at a live event using the system architecture of FIG. 2, according to an illustrative embodiment of the invention.

### DETAILED DESCRIPTION

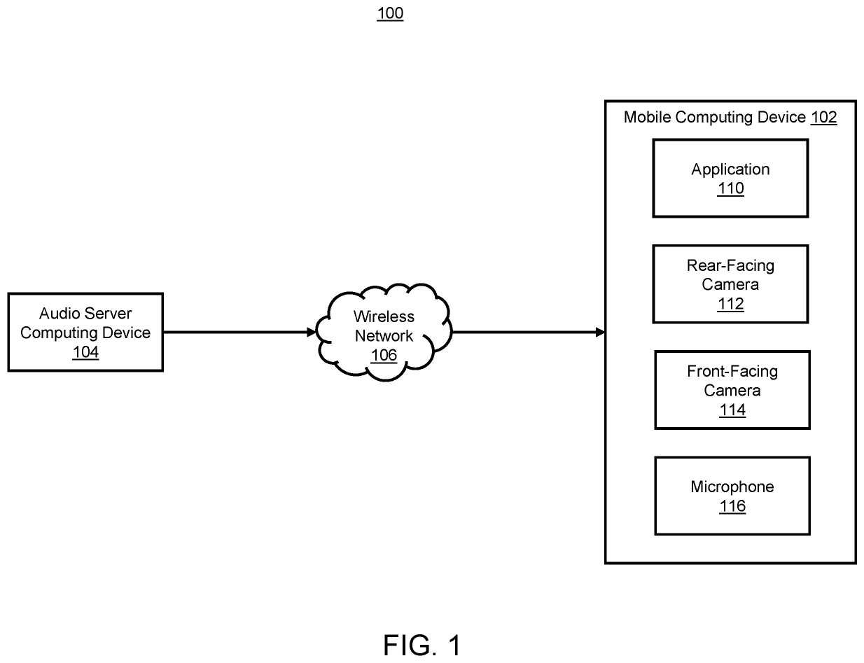

FIG. 1 is a schematic diagram of a system architecture 100 for wireless capture of real-time audio and video at a live event using a mobile computing device, according to an illustrative embodiment of the invention. System 100 includes a mobile computing device 102 communicatively coupled to an audio server computing device 104 over a wireless network 106. Mobile computing device 102 includes an application 110, a rear-facing camera 112, a front-facing camera 114, and a microphone 116. In some embodiments, the audio server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices.

Mobile computing device 102 is configured to receive instructions from application 110 in order to wirelessly capture real-time audio and video at a live event. For example, mobile computing device 102 is configured to receive a data representation of a live audio signal corresponding to the live event via wireless network 106. In some embodiments, the mobile computing device 102 receives the data representation of the live audio signal from the audio server computing device 104, which in turn is coupled to an audio source at the live event (e.g., a soundboard that is capturing the live audio). Mobile computing device 102 is also configured to process the data representation of the live audio signal into a live audio stream. Mobile computing device 102 is also configured to initiate a video capture corresponding to the live event. In some embodiments, a user attending the live event initiates the video capture using application 110. An exemplary application 110 can be an app downloaded to and installed on the mobile computing device 102 via, e.g., the Apple® App Store or the Google® Play Store. The user can launch application 110 on the mobile computing device 102 and interact with one or more user interface elements displayed by the application 110 on a screen of the mobile computing device 102 to initiate the video capture.

Mobile computing device 102 is also configured to, concurrent with the video capture, produce a shareable video corresponding to the live event based on the captured video and the live audio stream. Generally, the produced shareable video comprises high quality audio from the live audio stream alongside video captured by and from the perspective of a user attending the live event. For example, during video capture, the mobile computing device 102 can integrate the live audio stream corresponding to the live event with the captured video corresponding to the live event to produce the shareable video.

In some embodiments, mobile computing device 102 is further configured to upload the produced shareable video to a social network. For example, the mobile computing device 102 can be configured to transmit the produced shareable video via the wireless network 106 to a server computing device associated with the social network (not shown). Exemplary social networks include, but are not limited to, Facebook®, Instagram®, TikTok®, and YouTube®. In some embodiments, the mobile computing device 102 is configured to receive the data representation of the live audio signal corresponding to the live event from the audio server computing device 104 via the wireless network 106.

In some embodiments, video capture includes ambient audio captured by one or more microphones 116 of the mobile computing device. As an example, the ambient audio can comprise audio that corresponds to the live audio stream (i.e., audio relating to one or more performers at the live event, such as musicians on stage), but is being emitted by loudspeakers and captured by microphones 116 of the mobile computing device. The ambient audio captured by microphones 116 can also include audio from various sources in proximity to the mobile computing device 102, such as audience members, announcers, and other sources in the surrounding environment. In some embodiments, the produced shareable video includes the ambient audio from the video capture. In some embodiments, an audio mix including the live audio stream and the ambient audio is configurable by a user of the mobile computing device 102 via application 110. In some embodiments, each of the live audio stream and the ambient audio is received by application 110 as a separate channel, and a user of the mobile computing device 102 can adjust a relative volume of each channel to produce an audio mix that comprises both the live audio stream and the ambient audio according to the relative volume settings. For example, the application 110 can display a slider or knob to the user, with an indicator set to a middle position (indicating an equally balanced mix between the live audio stream and the ambient audio). When the user adjusts the indicator in one direction (e.g., left), the application 110 can increase the relative volume of the live audio stream and reduce the relative volume of the ambient audio. Similarly, when the user adjust the indicator in the other direction (e.g., right), the application 110 can increase the relative volume of the ambient audio and decrease the relative volume of the live audio stream.

In some embodiments, the video capture includes a first video feed from a rear-facing camera 112 of the mobile computing device 102 and a second video feed from a front-facing camera 114 of the mobile computing device 102. For example, in some embodiments, the produced shareable video includes video from the first video feed and the second video feed. In one example, the user can hold the mobile computing device 102 such that the field of view of the rear-facing camera 112 is pointing toward the live event (e.g., at the performers on stage) while the field of view of the front-facing camera 114 is pointing toward the user (e.g., to capture the user's reaction to the performance). In some embodiments, each of these video feeds is captured by the mobile computing device 102 as a separate video file or stream. In some embodiments, the mobile computing device 102 combines the first video feed and the second video feed into a combined video capture—for example, the second video feed from the front-facing camera can be overlaid in a portion (e.g., a corner) of the first video feed from the rear-facing camera so that each of the video feeds can be seen concurrently.

In some configurations, system 100 includes a headphone (not shown) communicatively coupled to the mobile computing device 102. The headphone may include a microphone (in addition to microphone 116). For example, in some embodiments, the mobile computing device 102 is configured to capture ambient audio using the headphone's microphone. In some embodiments, the mobile computing device 102 is configured to capture ambient audio using the headphone's microphone in response to the user initiating a camera flip using the application 110.

Audio server 104 is a computing device comprising specialized hardware and/or software modules that execute on one or more processors and interact with memory modules of the audio server computing device, to receive data from other components of the system 100, transmit data to other components of the system 100, and perform functions relating to wireless capture of real-time audio and video at a live event using a mobile computing device as described herein. In some embodiments, audio server computing device 104 is configured to receive a live audio signal from an audio source at the live event (e.g., a soundboard that is capturing the live audio) and transmit a data representation of the live audio signal via network 106 to one or more mobile computing devices 102.

In some embodiments, audio server computing device 104 can pre-process the live audio signal when generating the data representation of the live audio signal prior to transmission to mobile computing devices. For example, the audio server computing device 104 can generate one or more data packets corresponding to the live audio signal. In some embodiments, creating a data representation of the live audio signal includes using one of the following compression codecs: AAC, HE-AAC MP3, MPE VBR, Apple Lossless, IMA4, IMA ADPCM, or Opus.

Wireless network 106 is configured to communicate electronically with network hardware of the audio server computing device 104 and to transmit the data representation of the live audio signal to the mobile computing device 102. In some embodiments, the network 104 can support one or more routing schemes, e.g., unicast, multicast and/or broadcast.

Additional detail regarding illustrative technical features of the methods and systems described herein are found in U.S. Pat. No. 11,461,070, titled “Systems and Methods for Providing Real-Time Audio and Data” and issued Oct. 24, 2022; U.S. Pat. No. 11,625,213, titled “Systems and Methods for Providing Real-Time Audio and Data,” and issued Apr. 11, 2023; U.S. patent application Ser. No. 18/219,778, titled “Systems and Methods for Wireless Real-Time Audio and Video Capture at a Live Event,” published as U.S. Patent Application Publication No. 2024/0022769 on Jan. 18, 2024; and U.S. patent application Ser. No. 18/219,792, titled “Systems and Methods for Wireless Real-Time Audio and Video Capture at a Live Event,” published as U.S. Patent Application Publication No. 2024/0021218 on Jan. 18, 2024; the entirety of each of which is incorporated herein by reference.

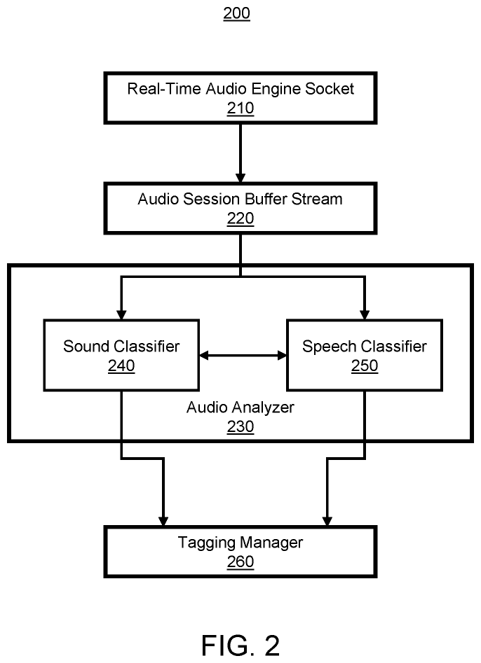

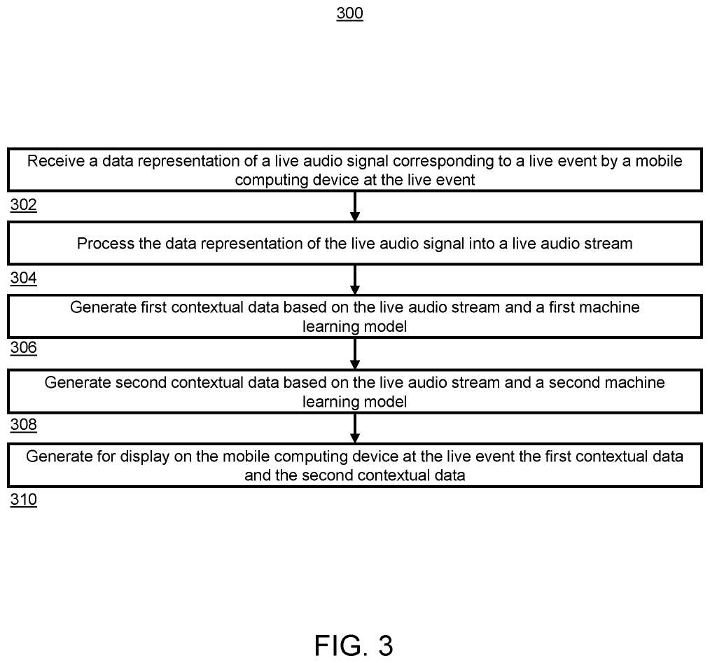

As can be appreciated, the methods and systems described herein are configured to integrate high-quality live event audio with user-captured video. In some embodiments, the integration is performed by the mobile computing device 102, which receives the high-quality live event audio from audio server computing device 104 and combines the live event audio with video captured by one or more cameras 114, 116 of mobile computing device 102 (as described with respect to FIGS. 2 and 3 below). In some embodiments, the integration is performed by the audio server computing device 104, which receives the captured video from the mobile computing device and combines the captured video with the live event audio.

FIG. 2 is a schematic diagram of a system architecture 200 for real-time analyzing of live event audio and tagging of user-captured video using a mobile computing device 102, according to an illustrative embodiment of the invention. System 200 includes a real-time audio engine socket 210 and an audio session buffer stream 220 transmitting data to audio analyzer 230. Audio analyzer 230 includes two components, sound classifier 240 and speech classifier 250, which transmits data to tagging manager 260. In some embodiments, some or all of real-time audio engine socket 210, audio session buffer stream 220, audio analyzer, sound classifier 240, speech classifier 250, and tagging manager 260 are components of application 110 in mobile computing device 102 (see FIG. 1).

Sound classifier 240 is configured to determine contextual data related to sounds based on one or more Signal-to-Noise Ratio (SNR) machine learning models. Generally, sound classifier 240 is a software module configured to receive the data representation of the live audio signal from real-time audio engine socket 210 via audio session buffer stream 220, convert the data representation into a live audio stream, and analyze the live audio stream to classify one or more sound-related features of the data representation. In some embodiments, sound classifier 240 is configured to convert the live audio stream into a format that is usable as input to one or more SNR machine learning models executed by sound classifier 240. As an example, sound classifier 240 can partition the data representation of the live audio signal into one or more segments, and for each segment, classifier 240 can convert the live audio stream associated with the segment into, e.g., a multidimensional feature vector that represents one or more sound-related characteristics of the segment. Sound classifier 240 can then process the feature vector(s) using one or more SNR machine learning models to generate a classification output for the segment. For example, the classification output for a given segment can comprise one or more labels that provide contextual data for the segment.

Typically, an SNR machine learning (ML) model is configured to analyze an incoming audio signal and differentiate between tonal aspects of the sound (e.g., voice, musical instruments) and non-tonal aspects (e.g., percussion). As just one example, sound classifier 240 can determine a particular musical key of the segment of the audio stream (e.g., “you're listening in the key of G”) using the SNR machine learning model processing described above. Other types of classification can include, but are not limited to, tempo (e.g., beats per minute), music style (e.g., rock, jazz, classical, etc.), and instrument type (e.g., saxophone, guitar, etc.). Exemplary SNR music analysis techniques are described in M. Muller et al., “Signal Processing for Music Analysis,” IEEE Journal of Selected Topics in Signal Processing, Vol. 5, Issue 6, October 2011, pp. 1088-1110, which is incorporated by reference herein. It should be appreciated that in some embodiments sound classifier 240 can aggregate classification output generated for each segment into an overall classification output for the entire live audio signal and transmit that output to tagging manager 260.

In some embodiments, sound classifier 240 can utilize multiple ML models to generate the contextual data—including, but not limited to, SNR models (described above), music genre classification models, music information retrieval models, and other types of audio analysis ML models. Exemplary music genre classification techniques that can be used in sound classifier 240 are described in A. Biswas et al., “Exploring Music Genre Classification: Algorithm Analysis and Deployment Architecture,” arXiv: 2309.04861v2 [cs.SD] September 14, 2023, available at arxiv.org/pdf/2309.04861.pdf, which is incorporated herein by reference. Exemplary music information retrieval techniques that can be used in sound classifier are described in Y. Deldjoo et al., “Content-driven music recommendation: Evolution, state of the art, and challenges,” Computer Science Review Vol. 51, February 2024, 100618, which is incorporated herein by reference. In some embodiments, the classification output from the SNR machine learning model(s) includes one or more text classification labels and/or one or more numeric classification values.

Similarly, speech classifier 250 is configured to determine contextual data related to speech based on one or more Automatic Speech Recognition (ASR) machine learning models. Generally, speech classifier 250 is a software module configured to receive the data representation of the live audio signal from real-time audio engine socket 210 via audio session buffer stream 220, convert the data representation into a live audio stream, and analyze the live audio stream to classify one or more speech-related features of the data representation. In some embodiments, speech classifier 250 is configured to convert the live audio stream into a format that is usable as input to one or more ASR machine learning models executed by speech classifier 250. As an example, speech classifier 250 can partition the live audio stream into one or more segments, and for each segment, classifier 250 can convert the live audio stream associated with the segment into, e.g., a multidimensional feature vector that represents one or more speech-related characteristics of the segment. Speech classifier 250 can then process the feature vector(s) using one or more ASR machine learning models to generate a classification output for the segment. For example, the classification output for a given segment can comprise one or more labels that provide contextual data for the segment. It should be appreciated that in some embodiments sound classifier 240 can aggregate classification output generated for each segment into an overall classification output for the entire live audio signal and transmit that output to tagging manager 260. As one example, speech classifier 250 can transcribe all or a portion of the speech contained in the live audio stream (such as song lyrics, keynote address, etc.). In another example, speech classifier 250 can analyze the speech to identify, e.g., a particular band, singer, song title or other characteristics of the performance and/or artist comprised in the live audio signal.

In some embodiments, speech classifier 250 can be toggled based on specific classification events—for example, when speech classifier 250 determines that a particular segment of the live audio signal does not contain any speech (e.g., guitar solo), audio analyzer 230 can toggle speech classifier 250 off. Exemplary automatic speech recognition techniques that can be used in speech classifier 250 are described in D. Yu and L. Deng, Automatic Speech Recognition: A Deep Learning Approach, ©Springer-Verlag London 2015, and M. Malik et al., “Automatic speech recognition: a survey,” Multimedia Tools and Applications Vol. 80, pp. 9411-9457 (2021), each of which is incorporated herein by reference. In some embodiments, sound classifier 240 and speech classifier 250 operate independently of each other, such that each classifier separately receives the live audio stream from audio session buffer stream 220 and processes the live audio stream in parallel to generate an individual classification for the live audio signal that is transmitted to tagging manager 260. In some embodiments, sound classifier 240 and speech classifier 250 can operate sequentially—for example, sound classifier 240 can process the live audio stream to generate one or more classifications for the live audio stream and then provide the classifications to speech classifier 250, which can incorporate the classifications into its analysis of the data representation (or vice versa).

Tagging manager 260 is configured to receive and filter the classification output received from each of sound classifier 240 and speech classifier 250, and generate contextual data (i.e., event/speech text, optionally with timestamps) associated with the live audio signal based upon the classification output. Generally, tagging manager 260 is a software module configured to convert the classification output for both sound-based characteristics and speech-based characteristics of the live audio signal (as received from classifiers 240 and 250) into contextual data (such as text labels) that can then be stored on mobile computing device 102 for, e.g., presentation to a user of the device via a display screen and/or integrated into the shareable video prior to transmission from mobile computing device 102 to a remote computing device. In some embodiments, tagging manager 260 can save the contextual data to a local file on mobile computing device 102.

FIG. 3 is a schematic flow diagram of a process 300 for generating and displaying contextual data at a live event using system 200, according to an illustrative embodiment of the invention. Process 300 begins by receiving a data representation of a live audio signal corresponding to the live event by a mobile computing device 102 via a wireless network 106 at step 302. In some embodiments, the mobile computing device 102 is configured to receive the data representation of the live audio signal corresponding to the live event from an audio server computing device 104 via the wireless network 106. Process 300 continues by processing the data representation of the live audio signal into a live audio stream at step 304.

Process 300 continues by generating first contextual data based on the live audio stream and a first machine learning model at step 306. For example, in some embodiments, the mobile computing device 102 is configured to use sound classifier 240 to generate the first contextual data. Process 300 continues by generating second contextual data based on the live audio stream and a second machine learning model at step 308. For example, in some embodiments, the mobile computing device 102 is configured to use speech classifier 250 to generate the second contextual data. In some embodiments, the first contextual data corresponds to sound data and the second contextual data corresponds to speech data. For example, in some embodiments, the first machine learning model includes a Signal-to-Noise Ratio (SNR) machine learning model. In some embodiments, the second machine learning model includes an Automatic Speech Recognition (ASR) machine learning model.

Process 300 finishes by generating for display on the mobile computing device 102 at the live event the first contextual data and the second contextual data at step 310. For example, in some embodiments, the mobile computing device 102 is configured to generate for display on the application 110 the first contextual data and the second contextual data.

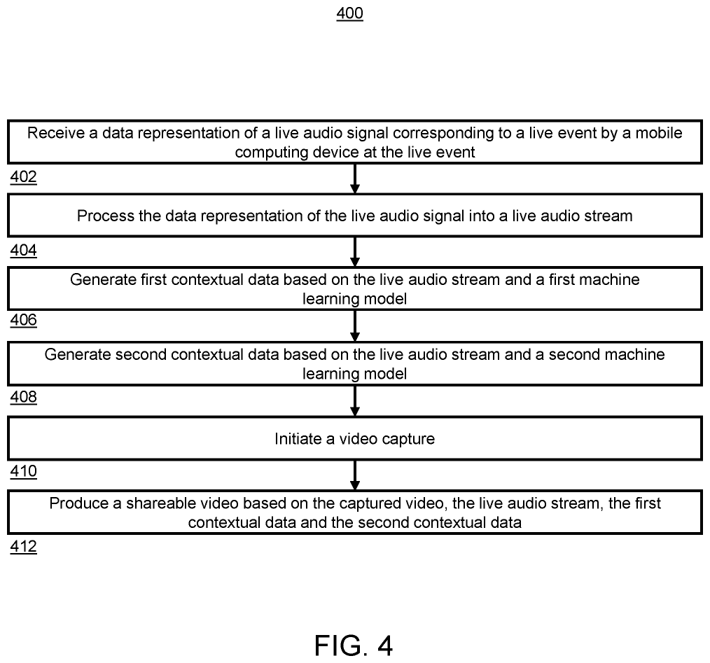

FIG. 4 is a schematic flow diagram of a process 400 for generating and tagging contextual data in a user-captured video at a live event using system 200, according to an illustrative embodiment of the invention. Process 400 begins by receiving a data representation of a live audio signal corresponding to a live event by a mobile computing device 102 via a wireless network 106 at step 402. In some embodiments, the mobile computing device 102 is configured to receive the data representation of the live audio signal corresponding to the live event from an audio server computing device 104 via the wireless network 106. Process 400 continues by processing the data representation of the live audio signal into a live audio stream at step 404.

Process 400 continues by generating first contextual data based on the live audio stream and a first machine learning model at step 406. For example, in some embodiments, the mobile computing device 102 is configured to use sound classifier 240 to generate the first contextual data. Process 400 continues by generating second contextual data based on the live audio stream and a second machine learning model at step 408. For example, in some embodiments, the mobile computing device 102 is configured to use speech classifier 250 to generate the second contextual data. In some embodiments, the first contextual data corresponds to sound data and the second contextual data corresponds to speech data. For example, in some embodiments, the first machine learning model includes a Signal-to-Noise Ratio (SNR) machine learning model. In some embodiments, the second machine learning model includes an Automatic Speech Recognition (ASR) machine learning model.

Process 400 continues by initiating a video capture corresponding to the live event at step 410. For example, in some embodiments, the mobile computing device 102 is configured to initiate the video capture using one of the rear-facing camera 112 and the front-facing camera 114.

Process 400 finishes by producing a shareable video corresponding to the live event based on the captured video, the live audio stream, the first contextual data, and the second contextual data at step 412. For example, in some embodiments, the mobile computing device is configured to produce the shareable video using tagging manager 260.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application, and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific preferred embodiments, it should be understood by those skilled in the art that various changes in form and detail may be made therein without departing from the spirit and scope of the invention as defined by the following claims. One skilled in the art will realize the subject matter may be embodied in other specific forms without departing from the spirit or essential characteristics thereof. The foregoing embodiments are therefore to be considered in all respects illustrative rather than limiting the subject matter described herein.

1. A computerized method for generating and displaying contextual data using a mobile computing device at a live event, the method comprising:
receiving, by a mobile computing device at a live event, a data representation of a live audio signal corresponding to the live event via a wireless network;
processing, by the mobile computing device at the live event, the data representation of the live audio signal into a live audio stream;
generating, by the mobile computing device at the live event, first contextual data based on the live audio stream and a first machine learning model;
generating, by the mobile computing device at the live event, second contextual data based on the live audio stream and a second machine learning model; and
generating, by the mobile computing device at the live event, for display on the mobile computing device at the live event the first contextual data and the second contextual data.

2. The computerized method of claim 1, wherein the mobile computing device is configured to receive the data representation of the live audio signal corresponding to the live event from an audio server computing device via the wireless network.

3. The computerized method of claim 1, wherein the first contextual data corresponds to sound data and the second contextual data corresponds to speech data.

4. The computerized method of claim 3, wherein the first machine learning model comprises a Signal-to-Noise Ratio (SNR) machine learning model.

5. The computerized method of claim 3, wherein the second machine learning model comprises an Automatic Speech Recognition (ASR) machine learning model.

6. A system for generating and displaying contextual data using a mobile computing device at a live event, the system comprising:
a mobile computing device communicatively coupled to an audio server computing device over a network, the mobile computing device configured to:
receive a data representation of a live audio signal corresponding to a live event via the wireless network;
process the data representation of the live audio signal into a live audio stream;
generate first contextual data based on the live audio stream and a first machine learning model;
generate second contextual data based on the live audio stream and a second machine learning model; and
generate for display on the mobile computing device at the live event the first contextual data and the second contextual data.

7. The system of claim 6, wherein the mobile computing device is configured to receive the data representation of the live audio signal corresponding to the live event from the audio server computing device via the wireless network.

8. The system of claim 6, wherein the first contextual data corresponds to sound data and the second contextual data corresponds to speech data.

9. The system of claim 8, wherein the first machine learning model comprises a Signal-to-Noise Ratio (SNR) machine learning model.

10. The system of claim 8, wherein the second machine learning model comprises an Automatic Speech Recognition (ASR) machine learning model.

11. A computerized method for generating and tagging contextual data in a user-captured video using a mobile computing device, the method comprising:
receiving, by a mobile computing device, a data representation of a live audio signal corresponding to a live event via a wireless network;
processing, by the mobile computing device, the data representation of the live audio signal into a live audio stream;
generating, by the mobile computing device, first contextual data based on the live audio stream and a first machine learning model;
generating, by the mobile computing device, second contextual data based on the live audio stream and a second machine learning model;
initiating, by the mobile computing device, a video capture corresponding to the live event; and
producing, by the mobile computing device, a shareable video corresponding to the live event based on the captured video, the live audio stream, the first contextual data, and the second contextual data.

12. The computerized method of claim 11, wherein the mobile computing device is configured to receive the data representation of the live audio signal corresponding to the live event from an audio server computing device via the wireless network.

13. The computerized method of claim 11, wherein the first contextual data corresponds to sound data and the second contextual data corresponds to speech data.

14. The computerized method of claim 13, wherein the first machine learning model comprises a Signal-to-Noise Ratio (SNR) machine learning model.

15. The computerized method of claim 13, wherein the second machine learning model comprises an Automatic Speech Recognition (ASR) machine learning model.

16. A system for generating and tagging contextual data in a user-captured video using a mobile computing device, the system comprising:
a mobile computing device communicatively coupled to an audio server computing device over a network, the mobile computing device configured to:
receive a data representation of a live audio signal corresponding to a live event via the wireless network;
process the data representation of the live audio signal into a live audio stream;
generate first contextual data based on the live audio stream and a first machine learning model;
generate second contextual data based on the live audio stream and a second machine learning model;
initiate a video capture corresponding to the live event; and
produce a shareable video corresponding to the live event based on the captured video, the live audio stream, the first contextual data, and the second contextual data.

17. The system of claim 16, wherein the mobile computing device is configured to receive the data representation of the live audio signal corresponding to the live event from the audio server computing device via the wireless network.

18. The system of claim 16, wherein the first contextual data corresponds to sound data and the second contextual data corresponds to speech data.

19. The system of claim 18, wherein the first machine learning model comprises a Signal-to-Noise Ratio (SNR) machine learning model.

20. The system of claim 18, wherein the second machine learning model comprises an Automatic Speech Recognition (ASR) machine learning model.
